(19) United States
(12) Patent Application Publication
(10) Pub. No.: US 2025/0384354 A1
(43) Pub. Date: Dec. 18, 2025

(54) SCALING ARTIFICIAL INTELLIGENCE MODELS WITH GRADIENT BOOSTING

(71) Applicant: The Toronto-Dominion Bank, Toronto (CA)

(72) Inventors: Jesse Cole Cresswell, Toronto (CA); Maksims Volkovs, Toronto (CA); Taewoo Kim, Toronto (CA)

(73) Assignee: The Toronto-Dominion Bank, Toronto, ON (CA)

(21) Appl. No.: 18/934,282

(22) Filed: Nov. 1, 2024

Related U.S. Application Data
(60) Provisional application No. 63/659,882, filed on Jun. 14, 2024.

(51) Int. Cl. G06N 20/20

(52) U.S. Cl. CPC G06N 20/20

(57) ABSTRACT

An example operation may include at least one of loading an Artificial Intelligence (AI) model from the storage, wherein the AI model is one of a diffusion-based model or a flow-based model, receiving tabular input data for execution by the AI model, wherein the tabular input data is scaled with a class-conditional scaler, creating a multi-output Gradient Boosted Tree (GBT), creating a Scalable AI (SAI) model from the AI model by using the multi-output GBT as a function approximator, and generating synthetic data by at least one of: executing the SAI model on the tabular input data or implementing a trained SAI model with the tabular input data, wherein the generating synthetic data reduces processing and memory resources.

### BACKGROUND

Tabular data generation is often developed on small datasets which do not match the scale of many scientific applications. Gradient-Boosted Trees, including XGBoost, perform well on tabular datasets but do not scale well to larger datasets for generative modeling. Therefore, there is a demand for an innovative solution that can efficiently scale generative modeling on small and large tabular datasets. Such a solution may significantly reduce the computational burden and cost associated with data preparation, enabling more rapid and effective training of machine learning models, and ultimately enhancing the performance and scalability of artificial intelligence (AI)-driven systems.

### SUMMARY

One example embodiment provides an apparatus that includes a memory and at least one processor, wherein the at least one processor and the memory are communicatively coupled, the at least one processor configured to perform at least one of load an Artificial Intelligence (AI) model, wherein the AI model is one of a diffusion-based model or a flow-based model, receive tabular input data for execution by the AI model, wherein the tabular input data is scaled with a class-conditional scaler, create a multi-output Gradient Boosted Tree (GBT), create a Scalable AI (SAI) model from the AI model by using the multi-output GBT as a function approximator, and generate synthetic data by at least one of: execute the SAI model on the tabular input data or implement a trained SAI model with the tabular input data, wherein the generation of the synthetic data reduces use of the at least one processor and of the memory.

Another example embodiment provides a method that includes at least one of loading an Artificial Intelligence (AI) model from the storage, wherein the AI model is one of a diffusion-based model or a flow-based model, receiving tabular input data for execution by the AI model, wherein the tabular input data is scaled with a class-conditional scaler, creating a multi-output Gradient Boosted Tree (GBT), creating a Scalable AI (SAI) model from the AI model by using the multi-output GBT as a function approximator, and generating synthetic data by at least one of: executing the SAI model on the tabular input data or implementing a trained SAI model with the tabular input data, wherein the generating synthetic data reduces processing and memory resources.

A further example embodiment provides a non-transitory computer-readable storage medium comprising instructions, that when read by a processor, cause the processor to perform at least one of loading an Artificial Intelligence (AI) model from the storage, wherein the AI model is one of a diffusion-based model or a flow-based model, receiving tabular input data for execution by the AI model, wherein the tabular input data is scaled with a class-conditional scaler, creating a multi-output Gradient Boosted Tree (GBT), creating a Scalable AI (SAI) model from the AI model by using the multi-output GBT as a function approximator, and generating synthetic data by at least one of: executing the SAI model on the tabular input data or implementing a trained SAI model with the tabular input data, wherein the generating synthetic data reduces processing and memory resources.

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into a classifier process according to the examples and features of the instant solution.

FIG. 2B is a diagram illustrating a process for developing an AI model that supports AI-assisted Scaling AI Models with Gradient Boosting according to the examples and features of the instant solution.

FIG. 2C is a diagram illustrating a process for utilizing an AI model that supports Scaling AI Models with Gradient Boosting according to examples and features of the instant solution.

FIG. 3 is a system diagram illustrating an operating environment for a product application service that provides Scaling AI Models with Gradient Boosting according to examples and features of the instant solution.

FIG. 4A is a diagram illustrating a method of scaling AI models with gradient boosting according to examples and features of the instant solution.

FIG. 4B is another diagram illustrating a method of scaling AI models with gradient boosting, according to examples and features of the instant solution.

FIG. 5 is a system diagram illustrating a computing environment according to the instant solution's example features, structures, or characteristics.

### DETAILED DESCRIPTION

The instant solution pertains to generative modelling on tabular data and specifically to generative modelling with Gradient-Boosted Trees on larger tabular datasets. The instant solution refines XGBoost (eXtreme Gradient Boosting), a Gradient-Boosted Tree framework, and uses the refined XGBoost as a function approximator on diffusion and flow-matching models on tabular data. The instant solution is configured to execute on computer systems, hosted compute infrastructure, Central Processing Units (CPU), Graphics Processing Units (GPU), Neural Processing Units (NPU), Tensor Processing Units (TPU), Artificial Intelligence (AI) Processor (AIP), other processing units, embedded computer systems, computer networks, wired and wireless compute devices, physical or virtual compute nodes. The instant solution additionally relates to systems and procedures, i.e. programming and configuration, for said generative modelling using Gradient-Boosted Trees.

The disclosure of the instant solution is expressed using terminology and concepts from Machine Learning (ML), artificial intelligence (AI), mathematics, statistics, and computer engineering. Examples include, but are not limited to, Large Language Model (LLM), Natural Language Processing (NLP), transformer, attention, In-Context Learning (ICL), k-Nearest Neighbor (kNN), k-means, gradient boosting, XGBoost, Area Under the receiver operating Characteristic Curve (AUC), Receive Operating Characteristic (ROC), Retrieval-Augmented Generation (RAG), normalization, hyperparameter, Tabular Data, Tabular Prior-Data Fitted Network (TabPFN), Symbolic Automatic INTegrator (SAINT), classifier, classification, classification task, training, annotated data, mean, average, standard deviation, confidence interval, bootstrapping, metric, probability, conditional probability, and probability distribution. These, as well as other similar terms, are well-known to someone with ordinary skills in the art and will be further described when required to illustrate a part of the instant solution.

The term “latent space”, also known as a “latent feature space” or “embedding space”, is an embedding of a set of items within a vector space, or more generally a manifold, in which items resembling each other are positioned closer to one another. The embedding vectors are often referred to as “latents”, “embeddings”, “embedding vectors”, or “vectors”. The terms vector, vector space, and manifold are well known to someone with ordinary skills in the art and will be further described when required to illustrate a part of the instant solution.

The disclosures of the instant solution are additionally expressed using the following well-known terms and techniques: “diffusion model”, “flow-based model”, “flow matching”, “ForestDiffusion”, and “ForestFlow”. A flow-based model is a type of generative model used in machine learning to model a probability distribution. A diffusion model is a type of generative model that creates new data by gradually transforming random noise into structured data. ForestDiffusion is a method of generating tabular data using a combination of diffusion and flow-based models. ForestFlow is a particular type of flow-matching model. These, and related terms, are well known to someone with ordinary skills in the art and will be further described when required to illustrate a part of the instant solution.

A Gradient Boosted Tree (GBT) is a machine learning algorithm that makes use of gradient descent for its calculations. GBT is an ensemble technique that combines multiple weak learners, typically decision trees, to create a stronger model. Decision Trees are predictive models that partition input data into distinct subsets via decision splits, culminating in terminal nodes, each providing a prediction. Decision Trees recursively partition the feature space to maximize the homogeneity of predictions within each partition. Gradient-Boosted Trees bring additional advantages, including not using significant pre-processing, efficient handling of missing data, and efficient training on Central Processing Units (CPUs) and vector processing units. XGBoost (extreme Gradient Boosting) is a well-known open-source library that provides implementations of gradient boosted decision trees and other gradient boosting algorithms. These, and related terms, are well known to someone with ordinary skills in the art and will be further described when required to illustrate a part of the instant solution.

The disclosure of the instant solution is expressed using terminology and concepts from computer systems and networking. Examples include, but are not limited to, Central Processing Unit (CPU), Graphics Processing Unit (GPU), Tensor Processing Unit (TPU), Neural Processing Unit (NPU), AI Processor (AIP), vector processor, memory, disk, storage, process, thread, client, server, node, host, virtual machine, stack, kernel, registers, segments, address space, networking, Transmission Control Protocol/Internet Protocol (TCP/IP), cloud, hosted, hosted node, cluster, operating system, containers and container management. These, as well as other similar terms, are well-known to someone with ordinary skills in the art and will be further described when required to illustrate a part of the instant solution.

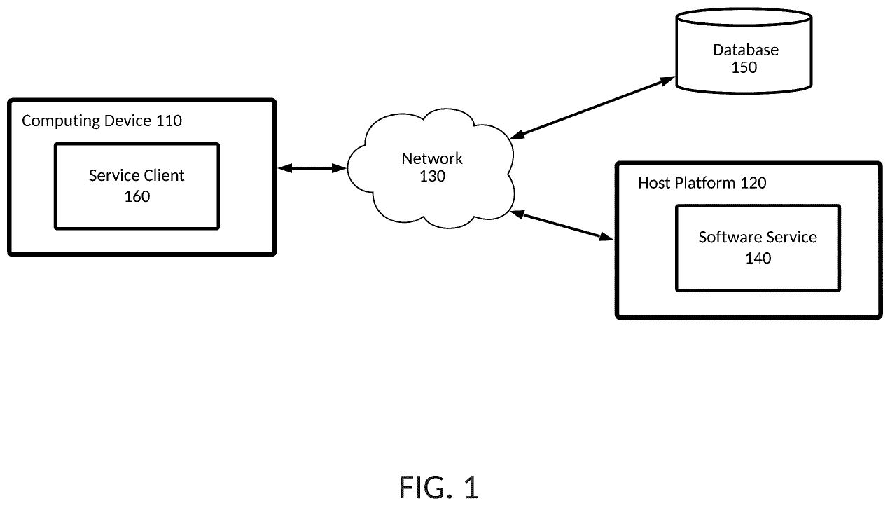

FIG. 1 is a system diagram illustrating an example operating environment 100 of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network or the like.

The software service 140 provides the service logic. It may provide one or more Application Programming Interfaces (APIs) for communicating with at least one service client 160. A “thick” user interface client that runs on a computing device 110 may utilize the APIs to communicate with the software service 140. Further, the software service 140 may provide hosted User Interfaces (UIs) that can be accessed through browser-based software on at least one computing device 110.

The at least one service client 160 can enable service access for end users and may come in a variety of forms including, but not limited to, a mobile device application (“app”) or a web portal accessed via a browser on a computing device 110 such as a laptop or desktop computer.

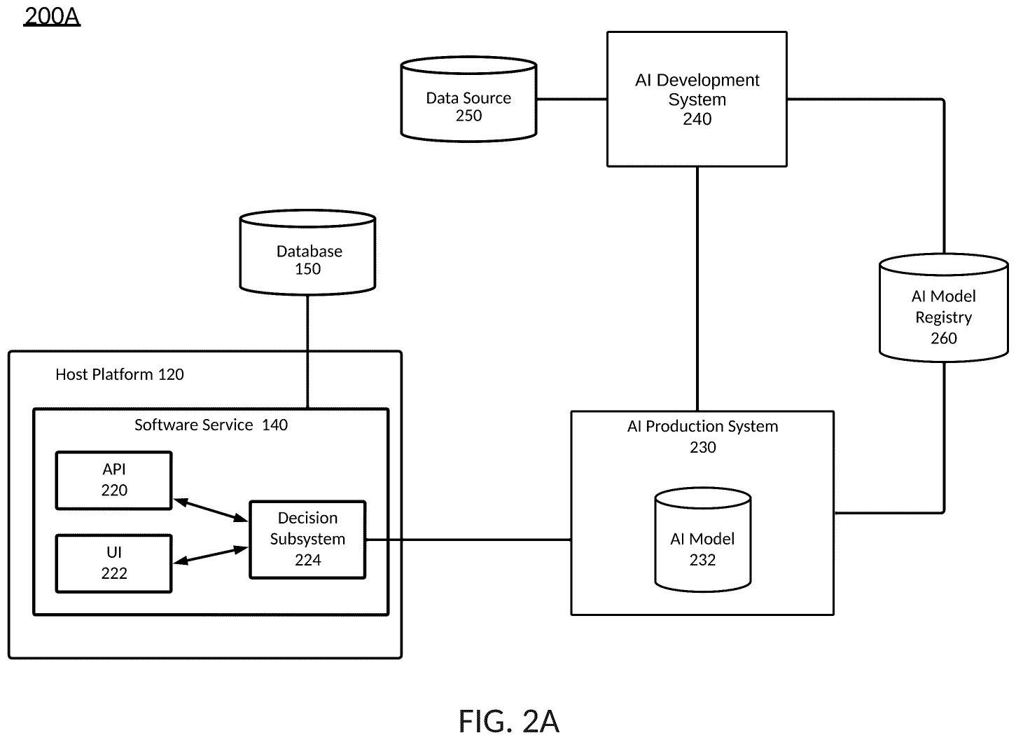

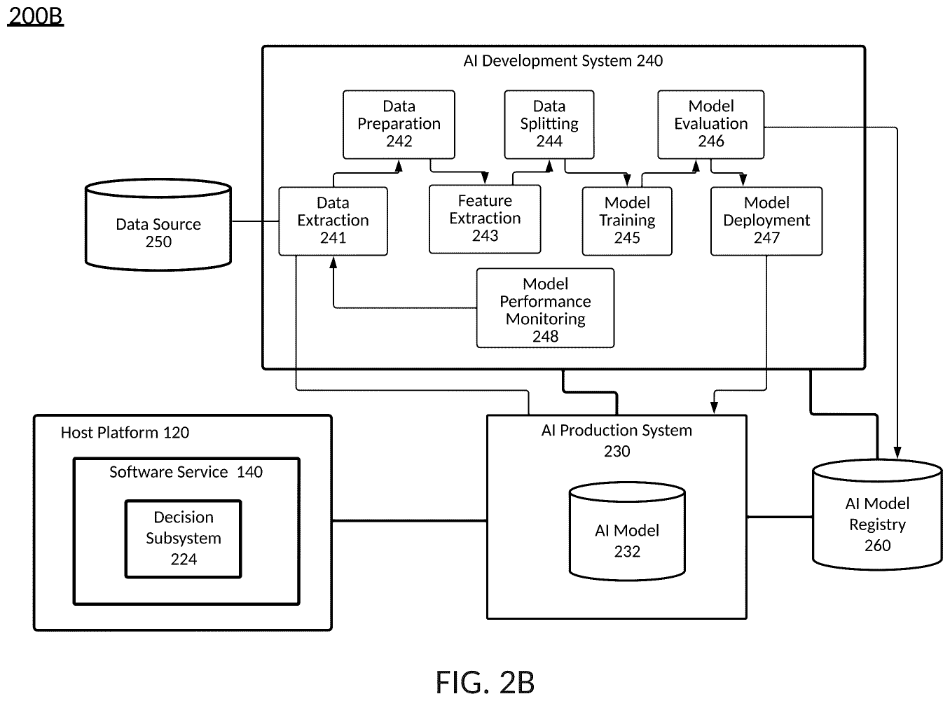

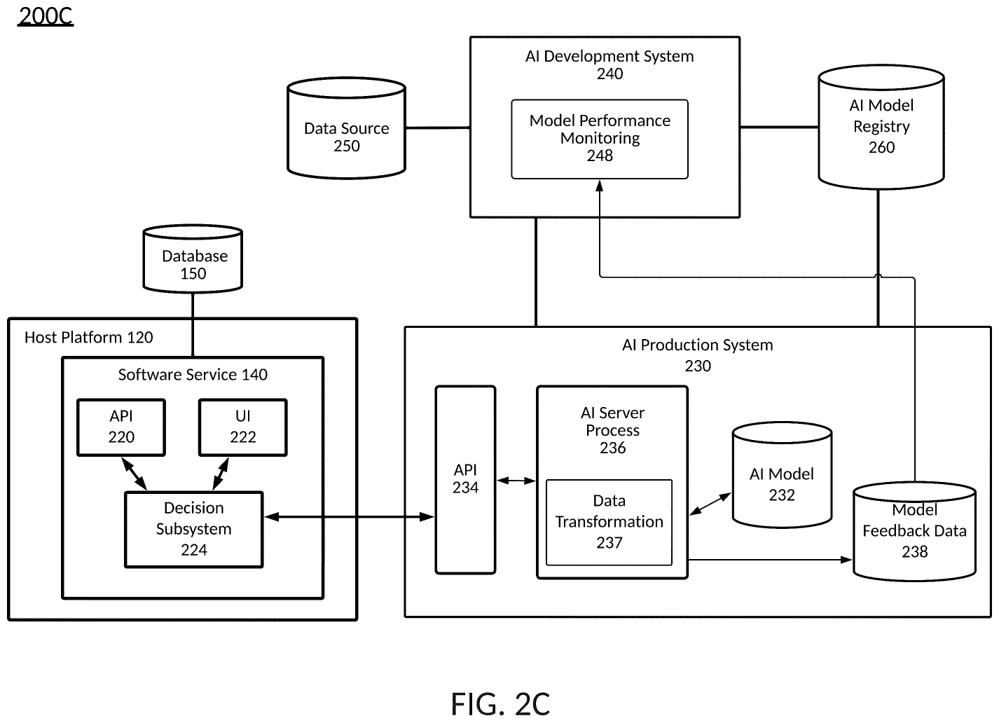

FIG. 2A illustrates an artificial intelligence (AI) network diagram 200A that supports AI-assisted Scaling AI Models with Gradient Boosting in a software service executing on a computer. While the example instant solution shown utilizes a scaling AI model, which is a type of machine learning (ML) model, other branches of AI, such as, but not limited to, computer vision, fuzzy logic, expert systems, neural networks, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide at least one application programming interface (API) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the at least one API 220 send data to at least one decision subsystem 224 of the software service 140 to assist in decision-making. In some examples and features of the instant solution, the software service 140 stores data included in API requests or data generated during processing the API requests into at least one database 150 (see FIGS. 1, 2A).

Software service 140 may provide at least one user interface (UI) 222, such as a server-side hosted graphical user interface (GUI). In some examples and features of the instant solution, the at least one UI 222 provided employ template-based frameworks, component-based frameworks, etc. In some examples and features of the instant solution, the at least one UI 222 send data to at least one decision subsystem 224 of the software service 140 to assist with decision-making. In some examples and features of the instant solution, the software service 140 stores data included in UI requests or data generated during processing the UI requests into at least one database 150.

Software service 140 may include at least one decision subsystem 224 that drive a decision-making process of the software service 140. In some examples and features of the instant solution, the at least one decision subsystem 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The at least one data source 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction 243 step. In some examples and features of the instant solution, a feature of the data is internal to the prepared data from the data preparation 242 step. In some examples and features of the instant solution, a feature of the data requires a piece of prepared data from the data preparation 242 step to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction 243 step is split 244 into a training and validation data set. The training data set is used to train the AI model 232, and the validation data set is used to evaluate the performance of the AI model 232 on unseen data.

The AI model 232 is trained and tuned 245 using the training data set from the data splitting 244 step. In this step, the training data set is provided to an AI algorithm and an initial set of algorithm parameters. The performance of the AI model 232 is then tested within the AI development system 240 utilizing the validation data set from 244 step. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from the data splitting 244 step is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation 246 step may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the at least one data source 250.

Once an AI model 232 has been validated and published to an AI model registry 260, it may be deployed during the model deployment 247 step to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from at least one other data source 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

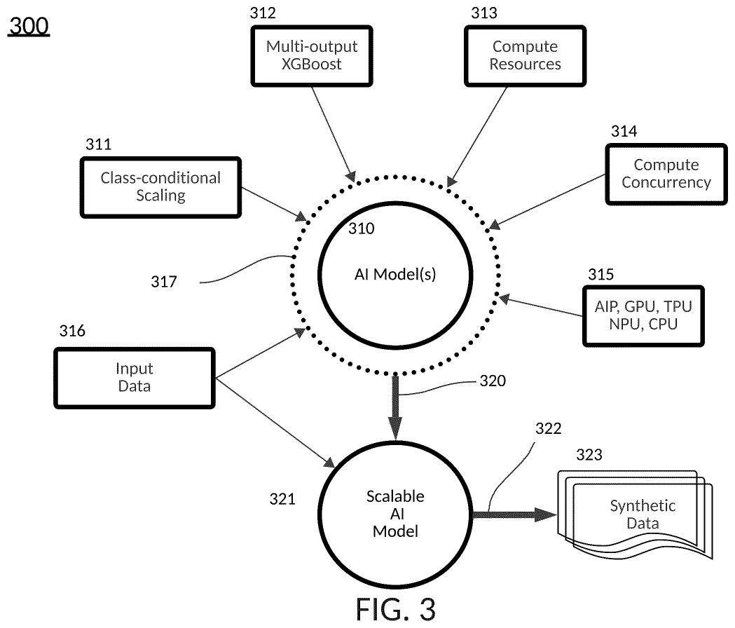

In some examples and features of the instant solution, FIG. 3 is a system diagram illustrating key aspects of an operating environment 300 of the instant solutions. The instant solution is a combination 317 of several techniques combined in a novel way to provide scalable generative modeling for diffusion and flow-matching generative models, such as AI models using ForestDiffusion and/or ForestFlow 310. The scalability features include one or more of class-conditional scaling 311, a multi-output XGBoost 312, reduction in the use of system compute resources 313 such as processing and memory, increased compute concurrency 314, and flexible use of at least one AIP, GPU, TPU, NPU and CPU 315.

In some examples and features of the instant solution, a combination 317 of one or more of the scalability features are combined to create 320 a Scalable AI Model 321 with increased performance and generative ability. The Scalable AI Model 321 is then used to generate 322 synthetic data 323.

In some examples and features of the instant solution, multi-output XGBoost 312 increases the capabilities and efficiency of the standard XGBoost by regressing multiple output targets concurrently. The multi-output regression means that the XGBoost algorithm predicts multiple output targets in parallel. By default, the standard XGBoost builds one model for each target. The multi-output enhanced XGBoost naturally captures correlations between output variables during generation due to the use of a single regressor. The use of a single multi-output regression demands less processing and memory as one regression prediction is performed, instead of one for each model for each target in the standard XGBoost. This increases the efficiency and training of the Scalable AI Model 321.

The input data 316 to a ForestDiffusion model includes tabular data, a statistical noise generator (typically Gaussian), and optionally data such as labels and non-modified data known as covariates. The generative ForestDiffusion model generates realistic synthetic data 323 that mimics the statistical properties of the input data 316 and imputes missing values in the input data 316. The synthetic data 323 thus mimics the statistical properties of the input data 316 and may be used for a variety of purposes to augment the input data 316 or in-place of the input data 316.

In some examples and features of the instant solution, performance and resource efficiency are increased using class-conditional scaling 311. AI models using ForestDiffusion and ForestFlow 310 expect input data of the same scale. The instant solution refines the scaling by introducing class-condition scaling 311 comprising a minimum-maximum on the data being regressed. Class-conditional scaling centers data with large variations, thereby increasing overall model performance.

In some examples and features of the instant solution, performance and resource efficiency are increased for compute resources 313 by freeing memory held by XGBoost when no longer used. In another example and feature, datasets are loaded into shared memory and accessed by multiple worker-threads or worker-processes. This avoids copying data into each worker-process and thus reduces memory consumption and increases concurrency and scalability. In another example and feature, each model is unloaded from memory, i.e. deallocated, when trained instead of holding the model in memory. This reduces memory consumption and increases scalability. In another example and feature, the use of worker-threads and worker-processes distributes and may balance processing load, may increase performance, and may reduce overall energy consumption.

In some examples and features of the instant solution, arrays are stored in shared memory as memory-mapped files, which impact compute resources 313 and compute concurrency 314. This provides increased concurrency.

In some examples and features of the instant solution, calculations are performed in 32-bit floating point, 64-bit floating point or a combination thereof, using one or more of processors AIP, GPU, TPU, NPU, CPU 315. In an example, all calculations are performed in 32-bit floating point, using one or more of processors AIP, GPU, TPU, NPU, CPU 315. In another example, calculations are performed as vector operations on one or more of an AIP, GPU, TPU, NPU, or CPU 315, thus increasing performance over serial calculations on a general-purpose CPU.

In some examples and features of the instant solution, an AI Model 310 is a combination 317 of one or more of class-conditional scaling 311, multi-output XGBoost 312, reduction of compute resources 313, increased compute concurrency 314, and utilization of AIP, GPU, TPU, NPU or CPU 315 to create 320 a Scalable AI Model 321. The Scalable AI Model 321 is then used to generate 322 one or more synthetic data 323 sets. The synthetic data 323 mimics the statistical properties of the input data 316 and may be used for a variety of purposes including augmentation of the input data 316 set, used in-place of the input data 316 to keep the input data private, used to diversify the input data 316 with similar data, used to train another model on the synthetic data 323, used as input by another model, or other uses of data statistically similar to the input data 316.

In some examples and features of the instant solution, the operating environment 300 may be an example of an AI development system 240 as described and depicted in FIGS. 2A-2C. In some examples and features of the instant solution, input data 316, refinements to class-conditional scaling 311, refinements to multi-output XGBoost 312, reduction to compute resources 313, increases to compute concurrency 314, flexible use of at least one AIP, GPU, TPU, NPU and CPU 315, an AI model using ForestDiffusion and/or ForestFlow 310, a scalable AI model 321, and synthetic data 323 may be retrieved from and/or may be stored in at least one data source 250, as described and depicted in FIGS. 2A-2C. In some examples and features of the instant solution, refinements to class-conditional scaling 311, refinements to multi-output XGBoost 312, reduction to compute resources 313, increases to compute concurrency 314, flexible use of at least one AIP, GPU, TPU, NPU and CPU 315, an AI model using ForestDiffusion and/or ForestFlow 310, and a scalable AI model 321 may include data extraction 241, data preparation 242, feature extraction 243, data splitting 244, model training 245, model evaluation 246, model deployment 247, and/or model performance monitoring 248, as described and depicted in FIGS. 2A-2C. In some examples and features of the instant solution the AI model using ForestDiffusion and/or ForestFlow 310 and the scalable AI model 321 may be examples of AI model 232, as described and depicted in FIGS. 2A-2C.

One practical application of the instant solution is generating refined synthetic data 323, from input tabular data, for example 316, as described and depicted in FIG. 3 and herein.

Another practical application of the instant solution is to use the generated synthetic data 323, as input to train or run another model, as described and depicted in FIG. 3 and herein.

Another practical application of the instant solution is to use the generated synthetic data 323, instead of the input data to preserve the privacy of the input data 316, as described and depicted in FIG. 3 and herein.

Another practical application of the instant solution is to use the generated synthetic data 323, to augment the input data 316 for other machine learning purposes, as described and depicted in FIG. 3 and herein.

Another practical application of the instant solution is regressing using a multi-output Gradient Boosting, such as multi-output XGBoost 312. This reduces the demand for processing cycles and memory, as described and depicted in FIG. 3 and herein.

Another practical application of the instant solution is refining the dynamic range of an AI Model 310, by class-conditional scaling 311, of the input tabular data as described and depicted in FIG. 3 and herein.

Another practical application of the instant solution is reducing compute resources 313, such as memory and processor utilization, by one or more of sharing data between processes, using shared memory, sharing memory using memory-mapped files, freeing allocated resources when no longer used, and performing calculations in the same floating-point resolution or as floating-point vector operations, as described and depicted in FIG. 3 and herein.

Another practical application of the instant solution is to increase compute concurrency 314, by at least one of sharing data between processes, using shared memory, and sharing memory using memory-mapped files, thereby avoiding copying data into one or more worker-processes, as described and depicted in FIG. 3 and herein.

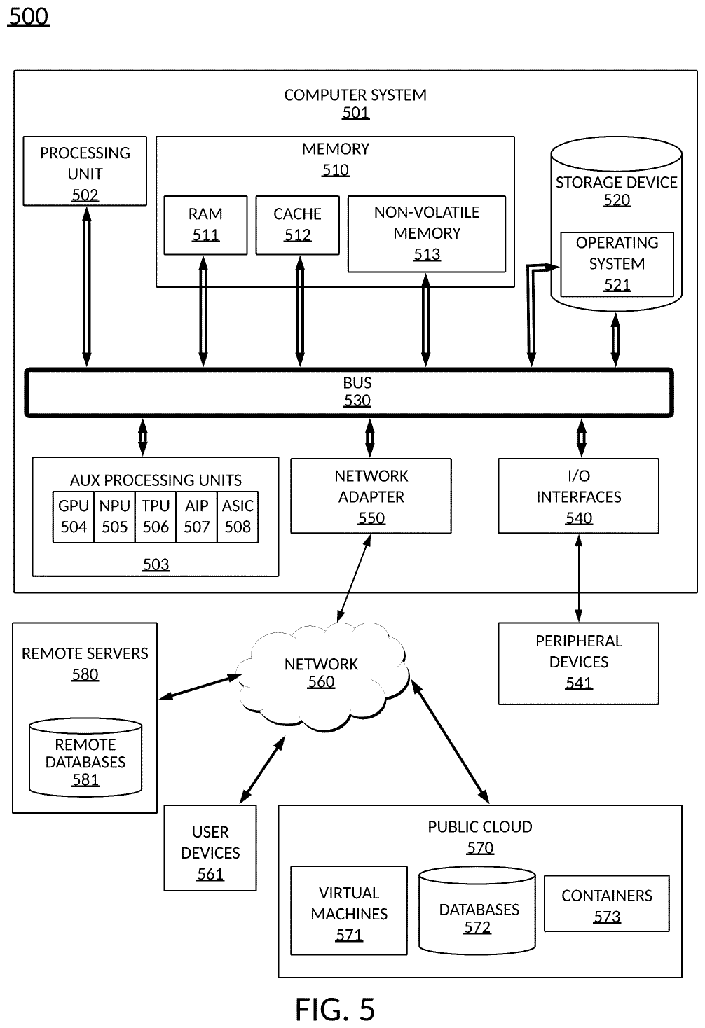

Another practical application of the instant solution is using auxiliary processing units, for example 315, to augment the processing and reduce processor utilization of the processing unit, for example 502 (FIG. 5), as described and depicted in FIG. 3 and herein.

The technical problem addressed by the instant solution arises from the limitations of existing generative modeling techniques when applied to large-scale, high-dimensional datasets, particularly in domains such as healthcare, finance, and telecommunications. Traditional generative models often cannot handle the complexity and variability inherent in such data, leading to scalability, accuracy, and resource efficiency issues. Specifically, models like single-output decision trees or conventional scaling methods cannot effectively manage the interdependencies between multiple output variables or dynamically adjust to changes in data distribution, resulting in suboptimal performance and increased computational burden. As AI-driven systems are increasingly deployed in resource-constrained environments like edge computing, there is demand for a scalable solution that can operate efficiently across diverse platforms and real-time scenarios.

Another challenge is ensuring the integrity, confidentiality, and utility of synthetic data generated for data augmentation or privacy-preserving data sharing. Existing methods often balance the trade-offs between data security and usability, particularly when dealing with sensitive information in regulated industries. The technical problem in this area is generating high-quality synthetic data that accurately represents the original datasets while incorporating robust security measures like encryption and data watermarking without compromising the data's analytical value or exposing sensitive details. The instant solution addresses these interconnected technical challenges by introducing a scalable AI model that integrates advanced techniques for resource management, real-time parameter adjustment, and data security, thereby enabling more reliable, efficient, and secure generative modeling across various real-world applications.

The instant solution provides a novel approach to addressing the challenges associated with large-scale, high-dimensional data by introducing a scalable AI model that integrates advanced techniques such as multi-output XGBoost, class-conditional scaling, and dynamic resource allocation. The AI model is designed to operate efficiently across diverse data types and real-world scenarios, dynamically adjusting its internal parameters—such as scaling factors, learning rates, and model architecture—in response to the characteristics of incoming data. This adaptability ensures that the model can handle complex interdependencies between output variables, maintain high accuracy despite data variability, and optimize computational resources based on the current workload. The solution further enhances computational efficiency by leveraging specialized hardware accelerators like NPUs, TPUs, and GPUs, making it well-suited for deployment in resource-constrained environments like edge computing.

The instant solution incorporates advanced security measures to ensure the integrity and confidentiality of synthetic data generated by the AI model. By embedding encryption and data watermarking techniques into the synthetic data generation process, the solution safeguards sensitive information while allowing the synthetic data to retain its utility for analytical purposes. A verification mechanism is also included to ensure that the synthetic data accurately reflects the statistical properties of the original data without exposing sensitive details, making the solution particularly valuable in regulated industries like healthcare and finance.

In one example of the instant solution, the multi-output XGBoost 312 technique employed by the instant solution addresses the limitations of traditional generative modeling when dealing with high-dimensional and heterogeneous datasets. For example, when processing data that includes both numerical and categorical variables, the multi-output XGBoost method excels by predicting multiple target variables concurrently, unlike conventional single-output models that handle these sequentially. This approach reduces computational overhead and enhances the model's ability to capture the interdependencies between output variables, resulting in more precise and reliable generative models.

Research in machine learning has shown that frameworks utilizing multi-output learning, such as the one integrated into the instant solution, can outperform traditional methods when output variables are interrelated. For example, multi-output XGBoost has demonstrated up to a 15% reduction in prediction error on complex, multi-dimensional datasets compared to single-output models, which predict each target variable independently. This performance boost is due to the model's capability to share information across outputs during the training phase, thereby refining its generalization on unseen data.

In cases where data sparsity poses a challenge, such as in medical datasets with missing values, the multi-output XGBoost method offers a robust solution by leveraging its ensemble-based approach to mitigate the effects of incomplete data. The ensemble of decision trees within XGBoost ensures that predictions remain accurate, even when missing data points, providing a clear advantage over traditional methods. Through these methodologies, the instant solution enhances model efficiency and ensures that the generated synthetic data 323 maintains high fidelity to the original input data 316, thus increasing its utility in downstream applications like predictive analytics and data augmentation.

This example of the instant solution demonstrates the scalable AI model 321 and showcases its adaptability to various data types and scenarios. As illustrated in FIG. 3, this adaptability underscores the instant solution's innovative aspects.

In another example of the instant solution, the healthcare sector presents a challenge due to the diversity of patient data, encompassing attributes such as age, medical history, and genetic information. Traditional scaling techniques often cannot account for this variability, leading to models that may not generalize across different patient groups. By implementing class-conditional scaling, the instant solution addresses this issue by tailoring the scaling process to the specific characteristics of each subgroup, thereby increasing the accuracy and reliability of predictive models used for tasks like disease diagnosis and treatment recommendations.

Market data is characterized by high volatility in financial applications, with asset prices and economic indicators fluctuating rapidly. The instant solution leverages class-conditional scaling to adjust scaling parameters in response to changing market conditions, ensuring that AI models used for stock price predictions or risk assessments maintain their accuracy even during sudden market shifts. This real-time adaptability offers a technical advantage, enabling the development of more reliable and responsive financial models.

In the telecommunications sector, network traffic data often exhibits variability due to user behavior, geographic location, and time of day. Class-conditional scaling within the instant solution enables the normalization of traffic data by class, such as different types of network packets or user segments. This approach increases the performance of models used for network optimization and anomaly detection by minimizing the impact of outliers and ensuring data scaling, which enhances the system's ability to detect and respond to network issues in real-time.

The application of class-conditional scaling has yielded a 20% increase in model accuracy when dealing with datasets that exhibit high variability compared to traditional scaling methods. This is notable when data distributions are skewed or when models are expected to generalize across diverse classes.

In a different example, the instant solution employs dynamic resource allocation techniques associated with compute resources 313 to optimize computing resource utilization in response to varying workloads. This approach ensures the system remains responsive to real-time demands, maintaining optimal performance while minimizing resource consumption. Specifically, the instant solution takes advantage of specialized hardware accelerators like NPUs and TPUs to boost computational efficiency during high-intensity tasks, such as training or executing AI models 310. For example, when handling large-scale tabular data with complex interdependencies, the solution allocates tasks to the most suitable processing units, ensuring that resources are used efficiently.

In another example, the instant solution's capabilities to generate 322 synthetic data 323 are applied across a range of practical applications for data augmentation in deep learning model training and for enabling privacy-preserving data sharing in collaborative environments. The synthetic data 323 generated by the scalable AI model 321 closely mirrors the statistical properties of the original input data 316, making it an effective tool for augmenting existing datasets without compromising data integrity or diversity. In deep learning contexts, synthetic data created by the AI model serves as valuable additional training examples, helping to prevent overfitting and refining the generalization of models in fields like computer vision and natural language processing, where diverse datasets are expected.

In collaborative settings, where data sharing occurs between organizations but comes with privacy concerns, the instant solution provides a secure alternative by generating synthetic data that retains the utility of the original datasets while protecting sensitive information. This approach is beneficial in healthcare, finance, and government sectors, where stringent data privacy regulations are in place and the risks associated with data breaches are high. Organizations can share insights without exposing confidential information by producing synthetic data that reflects the statistical structure of real data.

Using synthetic data for privacy-preserving purposes has been shown to reduce the risk of re-identification attacks while maintaining the predictive accuracy of models trained on such data. The instant solution's ability to generate high-quality synthetic data that balances privacy with utility represents a clear advantage over traditional anonymization techniques, which often degrade data quality and reduce model accuracy. The instant solution integrates advanced concurrency management techniques associated with compute concurrency 314 to enhance processing efficiency and throughput in various computing environments. These techniques, which include task scheduling, load balancing, and parallel processing, are orchestrated to ensure that computational tasks are executed with maximum efficiency when leveraging specialized hardware accelerators such as AIPs, GPUs, TPUs, NPUs, CPUs 315. Task scheduling assigns tasks to the most appropriate processors based on real-time workload analysis, minimizing idle times and boosting overall system performance.

In environments where computational load varies significantly, such as large-scale data processing or real-time analytics, the instant solution employs load balancing to distribute workloads evenly across available processors, preventing bottlenecks that may otherwise hinder performance. This dynamic load distribution ensures that no single processor becomes a limiting factor, thus maintaining high system efficiency. Parallel processing is also a key feature of the instant solution, enabling the concurrent execution of multiple tasks across different processing units. This capability benefits complex AI tasks requiring substantial computational resources, such as deep learning model training or large-scale data inference. By utilizing the parallel processing capabilities of AIPs, GPUs, and TPUs, the solution accelerates task completion and increases system throughput, allowing for the processing of larger datasets in shorter periods.

The strategic combination of task scheduling, load balancing, and parallel processing has been shown to reduce processing times by up to 30% and increase throughput by 25% compared to traditional sequential processing methods. These advancements highlight the role of optimized concurrency management in modern AI systems.

The instant solution features a dynamic adjustment system within the AI model 310 that analyzes incoming data and adjusts key parameters such as scaling factors, learning rates, or model architecture. This system enhances the AI model's adaptability, optimizing performance across various data types and real-world applications. By monitoring the characteristics of incoming data in real-time, the AI model can modify its internal parameters to align with the specific requirements of each dataset, thereby increasing both accuracy and efficiency. For example, when the AI model encounters data with variability or imbalance, the system adjusts the scaling factors associated with class-conditional scaling 311 to normalize the data before further processing. This real-time adjustment helps the model remain robust even when dealing with outlier-rich datasets in financial markets or imbalanced datasets in medical diagnostics. By optimizing the scaling process, the model reduces the risk of bias or variance, resulting in more reliable predictions.

The system also tunes the learning rate based on the complexity and volume of the incoming data. The AI model may lower the learning rate to achieve more precise convergence during training for more intricate datasets, such as high-resolution images or complex natural language texts. Conversely, the system increases the learning rate for simpler or sparser datasets to speed up the training process without sacrificing accuracy.

The system can adjust the model architecture in response to shifts in data distribution or unexpected changes in data patterns. This architectural flexibility ensures that the AI model remains well-suited to the task at hand, regardless of the nature of the data it encounters. The ability to restructure the model by adding or removing layers, altering the number of neurons, or changing activation functions further enhances the solution's adaptability to diverse data environments.

The instant solution also extends its scalable AI model 321 to function within an edge-computing architecture, where computational resources are limited and data processing is expected to occur close to the data source. This approach addresses the challenges of latency and resource optimization by distributing different components of the AI model across multiple edge computing devices 110.

For example, edge devices such as traffic cameras, environmental sensors, and local processing units are spread across a large area in a smart city scenario. The scalable AI model partitions its components, assigning tasks like data preprocessing, feature extraction, and inference generation to individual edge devices. Meanwhile, more resource-intensive processes like model training or complex analytics are centralized on a more capable edge node or within a nearby data center. This setup allows for local data processing, reducing latency compared to a centralized processing model.

The edge computing architecture also leverages the AI model's flexibility to adjust its computational demands based on the available resources of each edge device. For example, on a resource-constrained device with limited memory and processing power, the AI model might reduce the complexity of its operations by simplifying neural network layers or streamlining feature extraction processes. Conversely, on a more powerful edge device, the model can handle more sophisticated tasks, such as full-scale deep learning algorithms or real-time analytics, optimizing resource usage and performance across the network.

By processing data at the edge, the instant solution minimizes the time required to generate results and reduces the load on central servers, leading to a more scalable and resilient AI-driven system. This example of the instant solution showcases the instant solution's ability to operate in diverse and resource-limited environments, making it valuable in applications such as autonomous vehicles, industrial IoT, and remote healthcare monitoring.

The instant solution integrates advanced security measures, such as encryption and data watermarking, to protect the integrity and confidentiality of synthetic data 323 generated by the scalable AI model 321. These security enhancements are expected in sectors like healthcare and finance, where sensitive information is safeguarded.

For example, when synthetic data is created to supplement patient records in a healthcare setting, the instant solution encrypts the data using advanced cryptographic algorithms that comply with industry standards. This encryption ensures that even when the data were intercepted during transmission or compromised while in storage, it remains inaccessible to unauthorized users. Additionally, data watermarking techniques embed invisible identifiers within the synthetic data, enabling traceability and verification without affecting its usability. This watermarking helps prevent data leakage and ensures that any unauthorized use of the data can be traced back to the source, further enhancing security.

The solution also includes a verification mechanism that compares the statistical properties of the synthetic data with those of the original input data 316 to confirm that the synthetic data represents the input data without exposing sensitive information. This process involves analyzing key metrics such as data distribution, correlations, and variance to ensure that the synthetic data is a replica of the original data regarding structure and utility while being anonymized to prevent the re-identification of individuals or sensitive entities.

Integrating encryption and watermarking techniques in synthetic data generation processes is relevant in applications governed by strict data privacy regulations, such as the Health Insurance Portability and Accountability Act (HIPAA) in healthcare or the General Data Protection Regulation (GDPR) in finance.

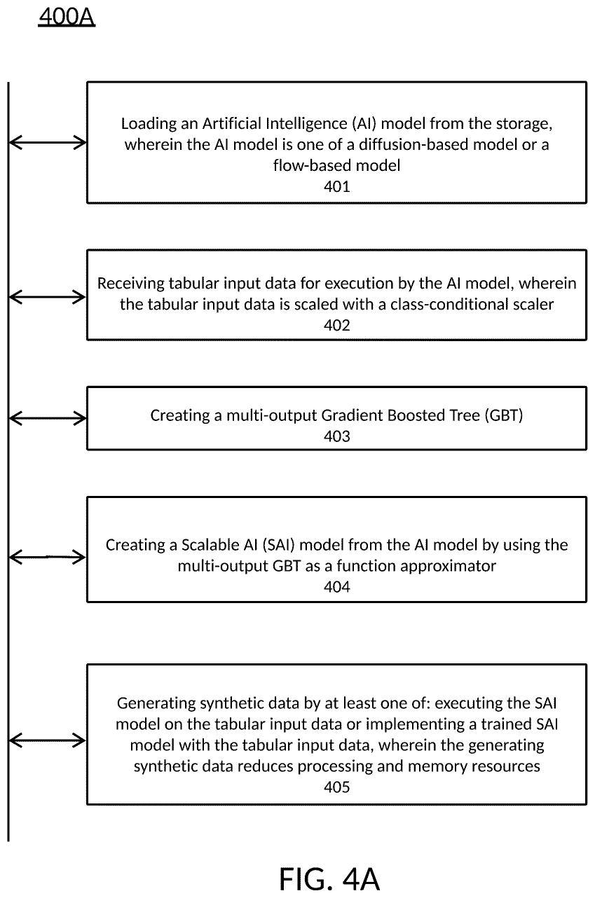

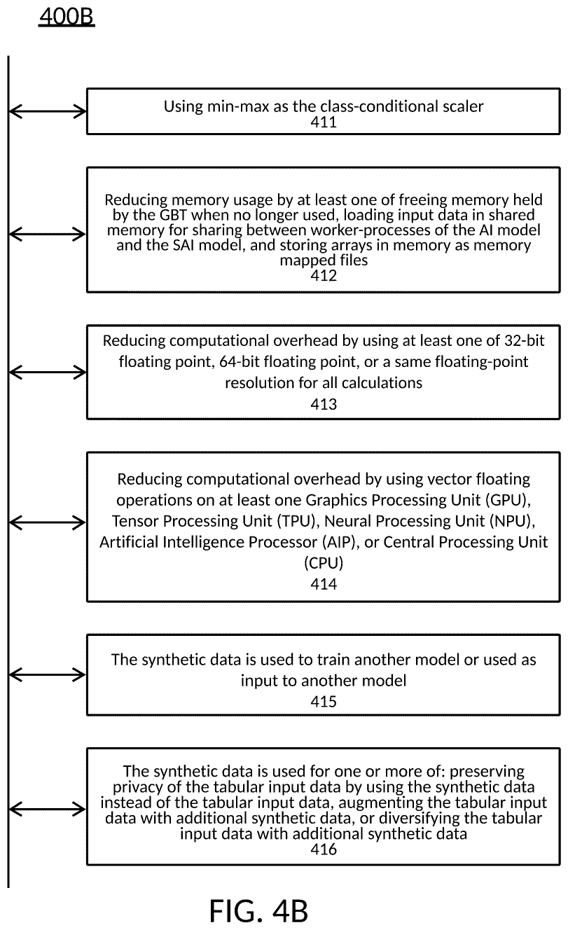

FIG. 4A is a diagram illustrating a method 400A of scaling AI models with gradient boosting, according to examples and features of the instant solution. For example, the method 400A may be performed by at least one processor of a host platform such as a cloud platform, a web server, a software application, a combination of systems, and the like. Referring to FIG. 4A, in 401, the method may include loading an Artificial Intelligence (AI) model from the storage, wherein the AI model is one of a diffusion-based model or a flow-based model. In 402, the method may include receiving tabular input data for execution by the AI model, wherein the tabular input data is scaled with a class-conditional scaler. In 403, the method may include creating a multi-output Gradient Boosted Tree (GBT). In 404, the method may include creating a Scalable AI (SAI) model from the AI model by using the multi-output GBT as a function approximator. In 405, the method may include generating synthetic data by at least one of: executing the SAI model on the tabular input data or implementing a trained SAI model with the tabular input data, wherein the generating synthetic data reduces processing and memory resources.

FIG. 4B is another diagram illustrating a method 400B of scaling AI models with gradient boosting, according to examples and features of the instant solution. For example, the method 400B may be performed by at least one processor of a host platform such as a cloud platform, a web server, a software application, a combination of systems, and the like. Referring to FIG. 4B, in 411, the method may include using min-max as the class-conditional scaler. In 412, the method may include reducing memory usage by at least one of freeing memory held by the GBT when no longer used, loading input data in shared memory for sharing between worker-processes of the AI model and the SAI model, and storing arrays in memory as memory mapped files. In 413, the method may include reducing computational overhead by using at least one of 32-bit floating point, 64-bit floating point, or a same floating-point resolution for all calculations. In 414, the method may include reducing computational overhead by using vector floating operations on at least one Graphics Processing Unit (GPU), Tensor Processing Unit (TPU), Neural Processing Unit (NPU), Artificial Intelligence Processor (AIP), or Central Processing Unit (CPU). In 415, the method may include the synthetic data used to train another model or used as input to another model. In 416, the method may include the synthetic data used for one or more of: preserving privacy of the tabular input data by using the synthetic data instead of the tabular input data, augmenting the tabular input data with additional synthetic data, or diversifying the tabular input data with additional synthetic data.

The examples and features of the instant solution may be implemented in one or more of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain one or more Graphics Processing Units (GPU) 504, Neural Processing Units (NPU) 505, Tensor Processing Units (TPU) 506, AI Processor (AIP) 507, or other Application Specific Integrated Circuit (ASIC) 508. Each of the APUs 503 may contain circuitry distributed over multiple integrated circuit chips. Each APU 503 may implement multiple processor threads and multiple processor cores. Each APU 503 may include one or more of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, one or more of the APUs 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing devices. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus for generating synthetic data comprising:
a memory; and
at least one processor, wherein the at least one processor and the memory are communicatively coupled, the at least one processor configured to:
load an Artificial Intelligence (AI) model, wherein the AI model is one of a diffusion-based model or a flow-based model;
receive tabular input data for execution by the AI model, wherein the tabular input data is scaled with a class-conditional scaler;
create a multi-output Gradient Boosted Tree (GBT);
create a Scalable AI (SAI) model from the AI model by using the multi-output GBT as a function approximator; and
generate synthetic data by at least one of:
execute the SAI model on the tabular input data; or
implement a trained SAI model with the tabular input data;
wherein the generation of the synthetic data reduces use of the at least one processor and of the memory.

2. The apparatus of claim 1, wherein the at least one processor is configured to use min-max as the class-conditional scaler.

3. The apparatus of claim 1, wherein the at least one processor is configured to reduce memory usage by at least one of:
deallocate memory held by the GBT when no longer used;
load input data into shared memory for sharing between worker-processes; and
store arrays as memory mapped files.

4. The apparatus of claim 1, wherein the at least one processor is configured to reduce computational overhead by using at least one of 32-bit floating point, 64-bit floating point, or a same floating-point resolution for all calculations.

5. The apparatus of claim 1, wherein the at least one processor is configured to reduce computational overhead by using vector floating operations on at least one Graphics Processing Unit (GPU), Tensor Processing Unit (TPU), Neural Processing Unit (NPU), Artificial Intelligence Processor (AIP), or Central Processing Unit (CPU).

6. The apparatus of claim 1, wherein the at least one processor is configured to use the synthetic data to train another model or use the synthetic data as input to another model.

7. The apparatus of claim 1, wherein the at least one processor is configured to perform at least one of:
preserve privacy of the tabular input data by using the synthetic data instead of the tabular input data;
augment the tabular input data with additional synthetic data; or
diversify the tabular input data with additional synthetic data.

8. A method of generating synthetic data comprising:
loading an Artificial Intelligence (AI) model from the storage, wherein the AI model is one of a diffusion-based model or a flow-based model;
receiving tabular input data for execution by the AI model, wherein the tabular input data is scaled with a class-conditional scaler;
creating a multi-output Gradient Boosted Tree (GBT);
creating a Scalable AI (SAI) model from the AI model by using the multi-output GBT as a function approximator; and
generating synthetic data by at least one of:
executing the SAI model on the tabular input data; or
implementing a trained SAI model with the tabular input data;
wherein the generating synthetic data reduces processing and memory resources.

9. The method of claim 8 comprising using min-max as the class-conditional scaler.

10. The method of claim 8 comprising reducing memory usage by at least one of freeing memory held by the GBT when no longer used, loading input data in shared memory for sharing between worker-processes of the AI model and the SAI model, and storing arrays in memory as memory mapped files.

11. The method of claim 8 comprising reducing computational overhead by using at least one of 32-bit floating point, 64-bit floating point, or a same floating-point resolution for all calculations.

12. The method of claim 8 comprising reducing computational overhead by using vector floating operations on at least one Graphics Processing Unit (GPU), Tensor Processing Unit (TPU), Neural Processing Unit (NPU), Artificial Intelligence Processor (AIP), or Central Processing Unit (CPU).

13. The method of claim 8, wherein the synthetic data is used to train another model or used as input to another model.

14. The method of claim 8, wherein the synthetic data is used for at least one of:
preserving privacy of the tabular input data by using the synthetic data instead of the tabular input data;
augmenting the tabular input data with additional synthetic data; or
diversifying the tabular input data with additional synthetic data.

15. A non-transitory computer-readable storage medium comprising instructions for generating synthetic data, that when read by a processor, cause the processor to perform:
loading an Artificial Intelligence (AI) model, wherein the AI model is one of a diffusion-based model or a flow-based model;
receiving tabular input data for execution by the AI model, wherein the tabular input data is scaled with a class-conditional scaler;
creating a multi-output Gradient Boosted Tree (GBT);
creating a Scalable AI (SAI) model from the AI model by using the multi-output GBT as a function approximator;
generating synthetic data by at least one of:
executing the SAI model on the tabular input data; or
implementing a trained SAI model with the tabular input data;
wherein the generating synthetic data reduces processing and memory resources.

16. The non-transitory computer-readable storage medium of claim 15, wherein the processor is configured to perform using min-max as the class-conditional scaler.

17. The non-transitory computer-readable storage medium of claim 15, wherein the processor is configured to perform reducing memory usage by at least one of freeing memory held by the GBT when no longer used, loading input data in shared memory for sharing between worker-processes of the AI model and the SAI model, and storing arrays in memory as memory mapped files.

18. The non-transitory computer-readable storage medium of claim 15, wherein the processor is configured to perform reducing computational overhead by using at least one of 32-bit floating point, 64-bit floating point, a same floating-point resolution for all calculations, or using vector floating operations on at least one Graphics Processing Unit (GPU), Tensor Processing Unit (TPU), Neural Processing Unit (NPU), Artificial Intelligence Processor (AIP), or Central Processing Unit (CPU).

19. The non-transitory computer-readable storage medium of claim 15, wherein the processor is configured to use the synthetic data to train another model or as input to another model.

20. The non-transitory computer-readable storage medium of claim 15, wherein the processor is configured to use the synthetic data for at least one of:
preserving privacy of the tabular input data by using the synthetic data instead of the tabular input data;
augmenting the tabular input data with additional synthetic data; or
diversifying the tabular input data with additional synthetic data.
